(19) United States
(12) Patent Application Publication
(10) Pub. No.: US 2015/0030932 A1
(43) Pub. Date: Jan. 29, 2015

(54) SECONDARY BATTERY AND METHOD FOR PRODUCING ALKALI-METAL-INCLUDING ACTIVE MATERIAL

(71) Applicant: DENSO CORPORATION, Kariya-city (JP)

(72) Inventors: Shuhei Yoshida, Nagoya-city (JP); Daisuke Shibata, Tokai-city (JP)

(21) Appl. No.: 14/338,635

(22) Filed: Jul. 23, 2014

(30) Foreign Application Priority Data
Jul. 25, 2013 (JP) 2013-154775
Feb. 13, 2014 (JP) 2014-025191

(51) Int. Cl. H01M 4/38; C01B 33/32; H01M 10/054; C01B 33/06; H01M 4/134; H01M 10/0525

(52) U.S. Cl. CPC H01M 4/381; H01M 4/134; H01M 10/0525; H01M 10/054; H01M 4/382; C01B 33/06; C01B 33/32; C01P 2006/40
USPC 429/231.9; 423/344; 423/332

(57) ABSTRACT

A method for producing an alkali-metal-including active material by pre-doping an active material with an alkali metal ion includes: mixing the alkali metal, an organic solvent with which the alkali metal is solvated, and a ligand having an electrophilic substitution reactivity to produce an alkali metal complex; and contacting and reacting the alkali metal complex and the active material with each other to pre-dope the active material with the alkali metal ion.

### CROSS REFERENCE TO RELATED APPLICATIONS

This application is based on Japanese Patent Applications No. 2013-154775 filed on Jul. 25, 2013, and No. 2014-25191 filed on Feb. 13, 2014, the disclosures of which are incorporated herein by reference.

### TECHNICAL FIELD

The present disclosure relates to a method for producing an alkali-metal-including active material, and a secondary battery having an electrode including an alkali-metal-including active material produced by the producing method.

### BACKGROUND

For the anode (anode active material) of an alkali secondary battery (for example, a lithium-ion secondary battery), a carbon or graphite based material has been used, which is advantageous for the charge/discharge cycle lifespan thereof, and costs. About the carbon or graphite based material, charge and discharge are attained by the occlusion and release of lithium ions into/from graphite crystal. Thus, a limitation is imposed onto the theoretical capacity (372 mAh/g) obtained from a graphite compound into which lithium is introduced at a maximum level (LiC₆). The charge/discharge capacity of an alloy based anode including Si, Sn or the like can be 4200 mAh/g as the maximum theoretical capacity. It can be considered that when compared with the carbon or graphite based anode, the alloy based anode becomes smaller in the weight proportion of the active material therein, thereby making it possible to be improved in energy density (Wh/g).

However, the alloy based anode has a problem of not being improved in energy density, and another problem of being remarkably changed in volume when lithium is inserted into or eliminated from the anode.

The former problem (about the energy density) is caused by the following: Si, Sn or the like is easily oxidized so that the anode surface is covered with the resultant oxide film; thus, when the battery concerned is electrically charged or discharged, Li ions react with the oxide film, so that a silicate and others are produced (SiOₓ+Li+4e⁻→Li_{α}SiO_{β}). In other words, Li released from the cathode is trapped into the anode to be lost, and thus the capacity of the cathode (electrode capacity) becomes small so that the energy density is not improved.

About the latter problem (about the volume change), the Si material expands about 4 times while graphite expands only 1.2 times. As the degree of the expansion is larger, conduction paths in the anode are more easily broken so that the battery does not come to function. For restraining the volume change, a method is conceivable which makes use of a Si carbon nano-complex, or SiO (in which Si is dispersed in SiO₂).

However, in this method, Si is used in the same manner as in the alloy-based anode; thus, the former problem (about the energy density) cannot be solved.

Hitherto, for solving the former problem (about the energy density), techniques about an organic electrolyte capacitor have been disclosed. An example thereof is disclosed in Patent Literature 1. An organic electrolyte capacitor in this literature has a cathode power collector and an anode power collector that each have a through-hole penetrating through the electrode between the front and rear surfaces of the electrode. This anode electrochemically contacts metal lithium, whereby the anode carries, thereon, ions of lithium inside the battery.

However, the technique described in Patent Literature 1 is merely a technique of bringing metal lithium into contact with its anode to cause ions of lithium to be carried on the anode. Only lithium ions of metal lithium which are present on a surface, for the contact, of the anode are carried on the anode. It is therefore very difficult to cause lithium ions to be carried uniformly on the whole of the anode. Moreover, lithium ions of metal lithium present in moieties that do not contact the anode (the moieties: an anode surface other than the above-mentioned contact surface of the anode, and the inside thereof) are not carried so that the ions become useless.

Patent Literature 1: WO 2003/003395 (corresponding to US 2004/0179328-A1)

### SUMMARY

It is an object of the present disclosure to provide a method for producing an alkali-metal-including active material, and a secondary battery having an electrode including an alkali-metal-including active material produced by the producing method. The producing method and the secondary battery provide to improve energy density, and to reduce remarkable volume change when lithium is inserted into or eliminated from the anode. Specifically, the producing method and the secondary battery provide: a first feature to dope an electrode or an active material itself uniformly; a second feature to make it possible to dope the same also with alkali metal ions other than Li ions; and a third feature to dope the same more efficiently with alkali metal ions according to the present producing method than a conventional method.

According to a first aspect of the present disclosure, a method for producing an alkali-metal-including active material by pre-doping an active material with an alkali metal ion includes: mixing the alkali metal, an organic solvent with which the alkali metal is solvated, and a ligand having an electrophilic substitution reactivity to produce an alkali metal complex; and contacting and reacting the alkali metal complex and the active material with each other to pre-dope the active material with the alkali metal ion.

According to the above method, in the complex-producing step, the alkali metal is converted into the alkali metal complex. In the pre-doping step, the active material is pre-doped with the alkali metal ions contained in the alkali metal complex. By making the alkali metal into the complex, the active material itself as well as an electrode in which the complex is used can be uniformly pre-doped with the ions. Moreover, the same can easily be pre-doped with not only lithium but also a different alkali metal difficult to handle, such as sodium or potassium. Furthermore, it is sufficient for the present disclosure that the alkali metal complex is produced by a quantity necessary for being blended with the active material. Thus, the same can be efficiently pre-doped with the alkali metal ions to restrain a waste of the alkali metal.

According to a second aspect of the present disclosure, a secondary battery includes: a first electrode including the alkali-metal-including active material produced by the producing method according to the first aspect; an electrolytic solution; and a second electrode that has a polarity opposite to the first electrode, and includes a material for absorbing and releasing the alkali metal ion with the electrolytic solution.

According to the above battery, the first electrode (for example, the anode) contains the alkali-metal-containing active material by the pre-doping. Thus, when the present battery is electrically charged or discharged, the alkali metal is not easily lost from the second electrode (for example, the cathode). Accordingly, the battery capacity of the secondary battery is increased by a quantity corresponding to the alkali metal quantity that has not been lost.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view illustrating an alkali metal complex and a pre-doping step;

FIG. 2 is a schematic sectional view illustrating a structural example of a pre-doping apparatus of a first embodiment of the present disclosure;

FIG. 3 is a graph showing an example of the relationship between the potential of an anode, and the capacity of a battery having the anode;

FIG. 4 is a graph showing an example of an X-ray diffraction pattern;

FIG. 5 is a schematic sectional view illustrating a structural example of a secondary battery of the first embodiment;

FIG. 6 is a schematic sectional view illustrating a structural example of the secondary battery of the first embodiment;

FIG. 7 is a schematic sectional view illustrating a structural example of the secondary battery of the first embodiment;

FIG. 8 is a graph showing an example of the relationship between the discharge capacity of each battery and the number of cycles;

FIG. 9 is a schematic view illustrating a structural example of a pre-doping apparatus of a second embodiment of the disclosure;

FIG. 10 is a schematic view illustrating a structural example of a pre-doping apparatus of a third embodiment thereof;

FIG. 11 is a schematic view illustrating a structural example of a pre-doping apparatus of a first modified embodiment thereof;

FIG. 12 is a schematic view illustrating a structural example of a pre-doping apparatus of a second modified embodiment thereof;

FIG. 13 is a schematic sectional view illustrating the structure of a secondary battery of Second Example;

FIG. 14 is a graph showing the charge/discharge cycle characteristic of a secondary battery of Example D1; and

FIG. 15 is a graph showing the charge/discharge cycle characteristic of a secondary battery of Example D2.

### DETAILED DESCRIPTION

Hereinafter, embodiments of the present disclosure will be described, referring to the drawings. Each of the drawings illustrates one or more elements necessary for the description of the disclosure, and thus the drawing does not necessarily illustrate the actual entire elements of the disclosure. When a direction or relative position is referred to by use of any word or wording, such as the word “upward”, “downward”, “right” or “left”, the standard thereof is based on the illustration on the drawing concerned.

### First Embodiment

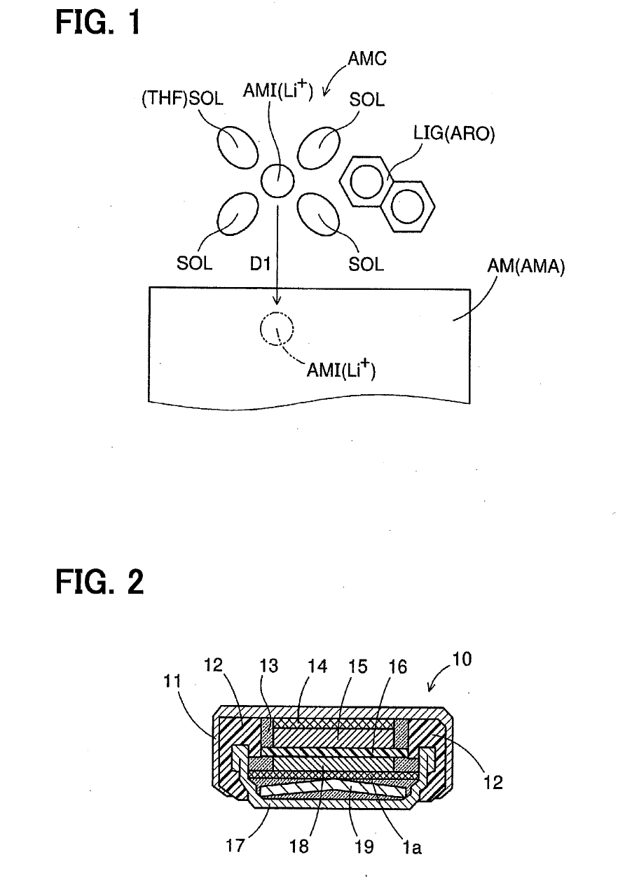

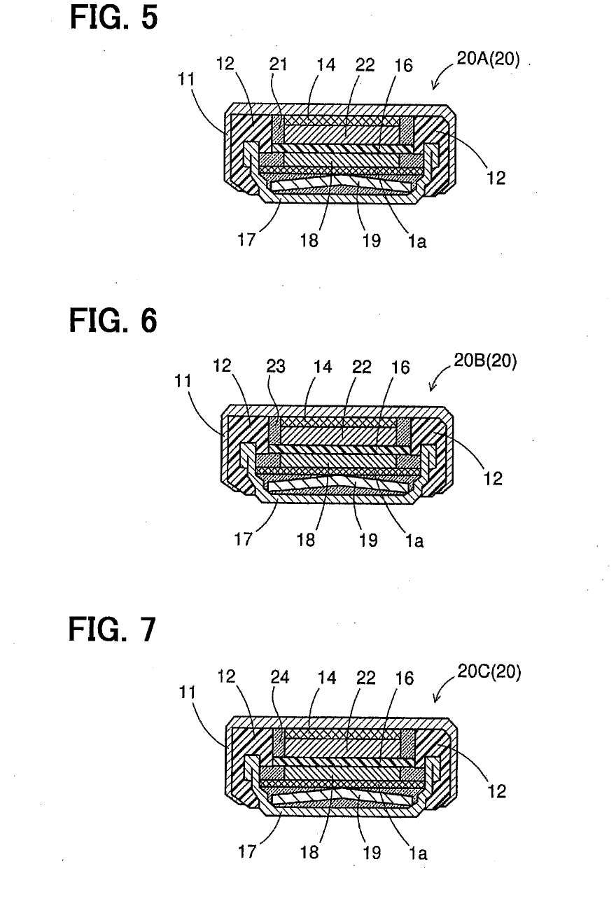

The present embodiment is described, referring to FIGS. 1 to 8. Specifically, a production of an alkali-metal-including active material according to the embodiment is described, referring to FIGS. 1 to 4; and a secondary battery according thereto is described, referring to FIGS. 5 to 8.

[Production of Alkali-Metal-Including Active Material]

The production of the alkali-metal-including active material has a complex-producing step and a pre-doping step. Each of the steps is concisely described below. Each of the steps can be advanced, irrelevantly to a fabrication of the secondary battery that will be described later.

Complex-Producing Step:

In the complex-producing step, the following are mixed with each other to produce an alkali metal complex: an alkali metal; an organic solvent with which the alkali metal is solvated; and a ligand having an electrophilic substitution reactivity.

The alkali metal is lithium (Li), sodium (Na), potassium (K), rubidium (Rb), cesium (Cs), or francium (Fr). The alkali metal may be a simple substance, or may be, in a broad sense, an alloy including any alkali metal.

The organic solvent may be a solvent the donor number (i.e., the Guttmann donor number, which has been described above) of which is a predetermined value (for example, 15) or more. The solvent is in particular desirably a cyclic carbonate, cyclic ester, linear ester, cyclic ether, linear ether or nitrile, or some other.

Examples of the cyclic carbonate include propylene carbonate (PC), ethylene carbonate (EC), and dimethylsulfoxide (DMSO). Examples of the cyclic ester include γ-butyrolactone, γ-valerolactone, γ-caprolactone, δ-hexanolactone, and δ-octanolactone. Examples of the linear ester include dimethyl carbonate (DMC), diethyl carbonate (DEC), and ethyl methyl carbonate (EMC). Examples of the cyclic ether include oxetane, tetrahydrofuran (THF), and tetrahydropyran (THP). Examples of the linear ether include dimethoxyethane (DME), ethoxymethoxyethane (EME), and diethoxyethane (DEE). Examples of the nitrile include acetonitrile, propionitrile, glutaronitrile, methoxyacetonitrile, and 3-methoxypropionitrile. Other examples of the organic solvent include hexamethylphosphoric triamide (HMPA), acetone (AC), N-methyl-2-pyrrolidone (NMP), dimethylacetoamide (DMA), pyridine, dimethylformamide (DMF), ethanol, formamide (FA), methanol, and water.

A mixed solvent is usable in which two or more of the above-mentioned solvents are mixed with each other. The mixed solvent is, for example, a mixed solvent in which a cyclic ester having a high dielectric constant is mixed with a linear ester for decreasing the whole of the solvent in viscosity. In order to improve the resultant battery in cycle characteristics, an unsaturated compound, which has an unsaturated bond, may be added to the solvent. Examples thereof include vinylene carbonate (VC), and fluoroethylene carbonate (FEC).

The ligand is desirably a substance having an aromatic ring which an electrophile easily attacks, that is, a polycyclic aromatic hydrocarbon or a polycyclic aromatic hydrocarbon group. Examples of the ligand having two rings include azulene, naphthalene, biphenylene, 1-methylnaphthalene, and sapotalin. Examples of the ligand having three rings include acenaphthene, acenaphthylene, anthracene, fluorene, phenalene, and phenanthrene. Examples of the ligand having four rings include benzoanthracene (benzo[a]anthracene), benzo[a]fluorene, benzo[c]phenanthrene, chrysene, fluoranthene, pyrene, tetracene, and triphenylene. Examples of the ligand having five rings include benzopyrene, benzo[a]pyrene, benzo[e]pyrene, benzo[a]fluoranthene, benzo[b]fluoranthene, benzo[j]fluoranthene, benzo[k]fluoranthene, dibenz[a,h]anthracene, dibenz[a,j]anthracene, pentacene, perylene, picene, and tetraphenylene. Examples of the ligand having six or more rings include anthanthrene, 1,12-benzoperylene, circulene, corannulene, coronene, dicoronylene, diindenoperylene, hericene, heptacene, hexacene, kekulene, ovalene, and zenthrene.

The polycyclic aromatic hydrocarbon or polycyclic aromatic hydrocarbon group is desirably one having a smaller electron affinity value than graphite, more desirably one having a negative electron affinity. The electron affinity value of a compound is calculable by molecular orbit calculation. It is allowable to use, as such values, values calculated and disclosed by NIST (National Institute of Standards and Technology; website: http://www.nist.gov/index.html).

In the complex-producing step, the alkali metal is oxidized by the above-mentioned organic solvent, so as to turn to an alkali metal ion.

Furthermore, by the electron affinity of the aromatic compound used as the ligand, and the electron donating performance of the solvating solvent, the alkali metal complex is produced in the solvating solvent. Examples of the group coordinated thereto include sulfone, hydroxyl, amino, phosphono, carboxyl, and thiol groups. A chemical formula representing a process for producing an example of the alkali metal complex is shown below. In the process, lithium (metal lithium) is used as the alkali metal, and the aromatic compound and the solvating solvent are represented by “ARO” and “SOL”, respectively. The produced alkali metal complex is [ARO⁻.Li⁺.SOL].

Metal Li+[ARO][SOL]→[ARO⁻.Li⁺.SOL] [Chem. 1]

FIG. 1 is an example of the alkali metal complex AMC produced, using lithium (Li) as the alkali metal, tetrahydrofuran (THF) as the solvating solvent (SOL), and naphthalene as the ligand LIG (aromatic compound ARO). In this example, a lithium ion (alkali metal ion AMI) is a center (central metal) of the complex. When the alkali metal complex AMC is produced, color change is caused (color reaction based on a spectroscopic property of the complex) in the same manner as when an ordinary complex is produced. Thus, it can be determined through visual observation whether or not the complex is produced.

Pre-Doping Step:

In the pre-doping step, the alkali metal complex produced through the complex-producing step is brought into contact with an active material to cause the two to react with each other, thereby pre-doping the active material with ions of the alkali metal.

The active material may be any substance capable of desolvating the alkali metal complex. In other words, the active material is a substance having no intercalation reactivity with the alkali metal. In order to increase the capacity of the battery, the active material is preferably an alloy type material. It is sufficient for the alloy type material to be an alloy material capable of occluding, eliminating, dissolving or precipitating the alkali metal with the advance of reaction of the battery. Specifically, the material is an alloy material which attains one or more of alloying, dealloying, compound-production, and compound-decomposition. The “alloy” may be composed of two or more metal elements, or composed of one or more metal elements, and one or more semimetal elements. The microstructure thereof may be a solid solution, eutectic (eutectic mixture) or intermetallic compound microstructure, or a mixed microstructure in which two or more of these microstructures coexist.

Examples of the metal element or semimetal element include magnesium (Mg), gallium (Ga), aluminum (Al), silicon (Si), germanium (Ge), tin (Sn), lead (Pb), arsenic (As), antimony (Sb), bismuth (Bi), silver (Ag), gold (Au), zinc (Zn), cadmium (Cd), mercury (Hg), copper (Cu), vanadium (V), indium (In), boron (B), zirconium (Zr), yttrium (Y), and hafnium (Hf). The alloy type material may include one or more of these elements in a simple substance form or in an alloy form.

It is particularly advisable to use, as the active material, a simple substance which consists of the following or an alloy which includes the same: any one of the metal elements or semimetal elements in Group 4B of the short-form periodic table. The active material is preferably silicon (Si) or tin (Sn), or any alloy thereof. The active material may be crystalline or amorphous.

The pre-doping step may be performed, using any apparatus. In the present embodiment, a pre-doping apparatus 10 illustrated in FIG. 2 is used to make the efficiency of the step high. The pre-doping apparatus 10, which is of a coin-cell type, has a cathode case 11, an electrically-insulating sealant (gasket) 12, a pre-doping liquid 13, a cathode power collector 14, an alkali metal piece 15, a separator 16, an anode case 17, an anode 18, a holding member 19, an anode power collector 1a, and others. Of these members, the cathode case 11, the sealant 12, the separator 16, the anode case 17, the holding member 19 and so on are optional members.

The cathode case 11 and the anode case 17 seal members held therein by the intervention of the sealant 12. The members are the pre-doping liquid 13, the cathode power collector 14, the alkali metal piece 15, the separator 16, the anode 18, the holding member 19, the anode power collector 1a, and so on.

The alkali metal piece 15 makes surface-contacts with the cathode case with the intervention of the cathode power collector 14 so that electric conduction is attained therebetween. The cathode power collector 14 is shaped from a conductive metal (such as aluminum). The shape of the alkali metal piece 15 is not limited. The cathode 18 makes surface-contacts with the anode case 17 with the intervention of the anode power collector 1a. The anode power collector 1a is shaped from a conductive metal (such as copper). The anode 18 includes the above-mentioned active material for being pre-doped.

The separator 16 interposed between the alkali metal piece 15 and the anode 18 takes charge of insulating the alkali metal piece 15 and the anode 18 electrically from each other and holding the pre-doping liquid 13. The separator 16 may be, for example, a porous synthetic resin membrane, in particular, a porous membrane made of a polyolefin polymer (such as polyethylene or polypropylene). In order to ensure the insulation, it is advisable to shape the separator 16 to have a larger dimension than the alkali metal piece 15 and the anode 18 have.

The cathode power collector 14, the alkali metal piece 15, the separator 16, the anode 18 and the anode power collector 1a are immersed in the pre-doping liquid 13. The pre-doping liquid 13 is the solvating solution SOL shown in FIG. 1, which includes the alkali metal complex AMC.

The holding member 19 takes charge of holding the cathode power collector 14, the alkyl metal piece 15, the separator 16, the anode 18 and the anode power collector 1a at respective determined positions thereof. These are easily held, using an elastic member such as an elastic piece or a spring.

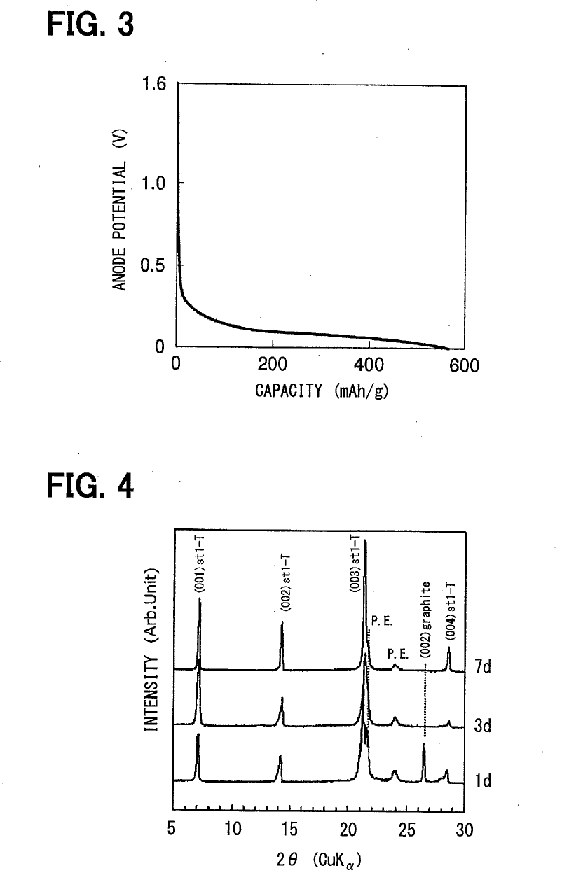

In the pre-doping step performed by the pre-doping apparatus 10, the active material is doped with the alkali metal ions AMI (occlusion of the ions) without conducting any intercalation reaction of the alkali metal. Specifically, the alkali metal ions AMI are subjected to de-solvation from the alkali metal complex AMC included in the pre-doping liquid 13, so that the active material AM included in the anode 18 is doped with the alkali metal ions (represented by an arrow D1 in FIG. 1). The dope amount of the alkali metal ions AMI for the active material AM is controllable in accordance with the concentration of the anionic reactant (i.e., the aromatic compound ARO) used when each of the alkali metal ions AMI functions as a center to produce any molecule of the alkali metal complex AMC. Thus, the dope amount can be set at will. The advance of the doping depends on chemical effect based on the electron affinity between the solvating solvent SOL plus the aromatic compound ARO, and the anode 18 (in particular, the active material AM). With the advance of the doping, the anode potential of the anode 18 is lowered as illustrated in FIG. 3. In other words, the active material AM of the anode 18 is being doped with the alkali metal ions AMI, so that the capacity of the anode 18 (battery capacity) is being increased.

In the case of using silicon (Si) as the active material AM, and lithium ions as the alkali metal ions AMI, a presumed mechanism of the doping is demonstrated through a chemical equation illustrated below.

xSi+y[ARO⁻.Li⁺.SOL]→Li₂₂Si₅+ . . . [Chem. 2]

wherein [ARO⁻.Li⁺.SOL] represents an alkali metal complex (see FIG. 1), and x and y are each any integer.

The right side of the chemical equation shows an example of an alloy of silicon and lithium that is capable of occluding lithium. Theoretically, Li₂₂Si₅ alloy occludes lithium at a maximum level. At room temperature, Li₁₅Si₄ alloy is a phase including lithium at a maximum level. As described herein, in accordance with such conditions, the metal capable of occluding lithium is varied; thus, the right side is shown to include the symbol “ . . . ”. Naturally, occluded lithium can also be released.

However, such a substance that is doped with the alkali metal complex AMC itself (co-intercalation of the complex) by intercalation reaction of the alkali metal is unsuitable for the active material AM. This substance is, for example, graphite. As represented by “(002) graphite” in FIG. 4, when graphite is used as the active material AM, the interlayer distance thereof is enlarged up to 12.44 Å with the doping. When graphite is doped with lithium ions, the interlayer distance is from about 5 to 8 Å. FIG. 4 shows an X-ray diffraction pattern of an example of graphite. In FIG. 4, its vertical axis and horizontal axis represent the diffraction intensity, and the diffraction angle (2θ; CuKα), respectively. As described herein, any substance doped with the alkali metal complex AMC itself increases the resistance value of the anode (in the case of graphite, the interlayer distance is increased). Thus, the substance is excluded from the active material AM.

[Secondary Battery]

The following will describe a production of a secondary battery 20 illustrated in each of FIGS. 5 to 7. The secondary battery 20, which is a coin-cell battery, has the same structure as the pre-doping apparatus 10 in FIG. 2 except its parts. Thus, the same reference number or signs are attached to the same elements in these figures as in FIG. 2, respectively. Any description thereabout is omitted.

A secondary battery 20A illustrated in FIG. 5 is an example of the secondary battery 20. In the pre-doping apparatus 10 illustrated in FIG. 2, the pre-doping is confirmed, and subsequently the apparatus is disassembled. Instead of the alkali metal piece 15, a cathode 22 including an alkali metal is used, and instead of the pre-doping liquid 13 an electrolytic solution 21 is used to fabricate these members and the other members. In this way, the secondary battery 20A can be produced. However, as an anode 18, the following is taken out and used: the anode in FIG. 2, in which the active material AM has been pre-doped with the alkali metal ions AMI in the pre-doping step. The taken-out anode 18 that has been subjected to the pre-doping step may be fabricated into the secondary battery 20A after the anode 18 is washed (for forming a coat) in the same way as in a second embodiment, which will be described later.

A secondary battery 20B illustrated in FIG. 6 is fabricated using a mixed solution 23 instead of the electrolytic solution 21 shown in FIG. 5. The secondary battery 20B is an example of the secondary battery 20. This mixed solution 23 is a solution in which a pre-doping liquid 13 and an electrolytic solution 21 are mixed with each other. By the use of the mixed solution 23, a complex-producing step and a pre-doping step as described above are advanced after the secondary battery 20B is fabricated. More specifically, regardless of the fabrication situation of the secondary battery 20B (i.e., whether this situation is a situation that the battery is being fabricated, or one that the battery has been already fabricated), the complex-producing step and the pre-doping step are advanced after the mixed solution 23 is injected.

The electrolytic solution 21 incorporated into the mixed solution 23 is desirably an organic solvent having a donor number of a predetermined value (for example, 15) or more. It is advisable to use the same material (substance) for the pre-doping liquid 13 and the electrolytic solution 21 as far as the material has a donor number of the predetermined value or more. The process described herein makes it possible to attain the production of the secondary battery 20B and the pre-doping of the active material AM with the alkali metal ions AMI. The aromatic compound ARO included in the mixed solution 23 can be removed since the compound is decomposed into a gas at the time of charging and discharging the battery firstly.

A secondary battery 20C illustrated in FIG. 7 is fabricated, using a mixed electrolytic solution 24 instead of the electrolytic solution 21 shown in FIG. 5. The secondary battery 20C is an example of the secondary battery 20. The mixed electrolytic solution 24 is a solution in which the alkali metal complex AMC produced through the above-mentioned complex-producing step and the electrolytic solution 21 are mixed with each other. By the use of the mixed electrolytic solution 24, a pre-doping step as described above is advanced after the secondary battery 20C is fabricated. More specifically, regardless of the fabrication situation of the secondary battery 20C, the pre-doping step is advanced after the mixed solution 24 is injected. The process described herein makes it possible to attain the production of the secondary battery 20C and the pre-doping of the active material AM with the alkali metal ions AMI. The aromatic compound ARO included in the mixed solution 24 can be removed since the compound is decomposed into a gas at the time of charging and discharging the battery firstly.

The following will concisely describe the cathode 22 and the electrolytic solution 21 common to the secondary batteries 20 (20A, 20B and 20C) illustrated in FIGS. 5 to 7.

The cathode 22 may be an electrode made of any substance as far as the electrode can release alkali metal ions. When the alkali metal ions are, for example, lithium ions, the cathode 22 may be an electrode including LiMn₂O₄ as a cathode active material. The nonaqueous electrolytic solution therefor may be any electrolytic solution as far as the electrolytic solution includes a carbonate as a solvent. This electrolytic solution may be an electrolytic solution in which an appropriate quantity of a lithium salt such as LiBF₄ is dissolved in a mixed solvent composed of a high-dielectric-constant solvent such as ethylene carbonate, and a low-viscosity solvent such as diethyl carbonate at the ratio by volume between the two being an appropriate value. The electrolytic solution may be a mixed solvent in which an ether or phosphoester organic solvent is blended into a carbonate organic solvent.

The electrolytic solution 21 (electrolyte) may be any nonaqueous electrolyte including an alkali metal. When a supporting electrolyte is dissolved into the above-mentioned organic solvent, the resultant acts as the electrolyte (electrolytic solution). The supporting electrolyte may be any salt suitable for the supporting. When the alkali metal is, for example, lithium, examples of the supporting salt include salt compounds such as LiPF₆, LiBF₄, LiAsF₆, LiCF₃SO₃, LiN(CF₃SO₂)₂, LiC(CF₃SO₂)₃, LiSbF₆, LiSCN, LiClO₄, LiAlCl₄, NaClO₄, NaBF₄, and NaI; and derivatives of these salts. In order to improve the cathode particularly in electrical characteristics, it is preferred to use one or more salts selected from the group consisting of LiPF₆, LiBF₄, LiClO₄, LiAsF₆, LiCF₃SO₃, LiN(CF₃SO₂)₂, LiC(CF₃SO₂)₃, LiN(FSO₂)₂, LiN(CF₃SO₂)(C₄F₉SO₂), derivatives of LiCF₃SO₃, derivatives of LiN(CF₃SO₂)₂, and derivatives of LiC(CF₃SO₂)₃.

The supporting salt may be an oxalate complex or oxalate derivative complex instead of (or in addition to) two or more of the above-mentioned supporting salts. Examples of the oxalate complex or oxalate derivative complex lithium bis(oxalato) borate (LiBOB), lithium difluoro(oxalato) borate (LiFOB), lithium difluorobis(oxalato) phosphate, and lithium bis(oxalato)silane. About any alkali metal other than lithium (such as sodium or potassium) also, the same supporting salts are each usable.

Instead of (or in addition to) the above-mentioned organic solvents or supporting salts, an ionic liquid usable for a nonaqueous electrolyte secondary battery may be used. Examples of a cationic component of the ionic liquid include N-methyl-N-propylpiperidinium, and dimethylethylmethoxyammonium cations. Examples of an anionic component thereof include BF₄⁻, and N(SO₂CF₃)₂⁻. The nonaqueous electrolyte may be made into a gel form by incorporating a gelatinizer into the electrolyte.

### Second Embodiment

The present embodiment is described, referring to FIG. 9. Specifically, referring to FIG. 9, a description is made about a production according to the embodiment of an anode which includes an alkali-metal-including active material. In the embodiment, structural factors and members, and others not referred to herein are the same as in the first embodiment.

[Production of Alkali-Metal-Including Active Material]

The production of an alkali-metal-including active material has a complex-producing step, a pre-doping step, and a washing step.

The complex-producing step is performed in the same way as in the first embodiment.

In the pre-doping step, an active material is immersed in the pre-doping liquid produced in the complex-producing step to bring the two into contact with each other, thereby causing the two to react with each other to pre-dope the active material with ions of the alkali metal. This pre-doping liquid may be the same pre-doping liquid as used in the first embodiment.

In the washing step, the pre-doping liquid remaining on one or each external surface of the active material is washed/removed.

In the present embodiment, a pre-doping apparatus 30 (30A) illustrated in FIG. 9 is used to perform the pre-doping step and the washing step. The pre-doping apparatus 30 has a pre-doping tank 32 in which a pre-doping liquid 33 is stored; a washing tank 34 in which a washing liquid 35 for washing the pre-doping liquid 33 is stored; and others. The pre-doping apparatus 30 also has devices not illustrated, such as a carrying device.

The pre-doping liquid 33 is the same organic solvating solvent SOL as in the first embodiment.

The washing liquid 35 is a solution for removing the pre-doping liquid 33 adhering onto the anode 18, and may be an organic solvent of the pre-doping liquid 33.

In an anode 18, an anode active material AM is arranged on external surfaces of an anode power collector, la. In the present embodiment, the anode 18 is an anode in which anode mixture layers 31 are arranged on the respective external surfaces of the anode power collector is by painting a slurry in which a powder for the anode active material AM is dispersed, together with additives such as a conductant and a binder, into a solvent, and then drying the slurry. The anode mixture layers 31 of the anode 18 may be compressed after the drying. The anode active material AM may be painted onto both of the external surfaces of the anode power collector 1a (FIG. 9), or may be painted onto one of the external surfaces. In the case of the secondary battery 20 illustrated in FIG. 5, the structure thereof is preferably a structure in which the anode active material AM is painted on one of the two external surfaces of its anode power collector. The anode 18 is a long member in the form of a band extended continuously into the longitudinal direction of the member.

In the pre-doping apparatus, the band-form anode 18 is continuously carried to make the advancing direction thereof to be consistent with the longitudinal direction (a direction of an arrow in FIG. 9). First, the pre-doping step is advanced, in which the anode 18 is immersed in the pre-doping liquid 33 in the pre-doping tank 32 for a predetermined period. Specifically, the anode 18 is carried to be passed in the pre-doping liquid 33 over a predetermined period. At this time, the anode active material AM contacts an alkali metal complex AMC so that the two react with each other to pre-dope the anode active material AM with ions AMI of the alkali metal. After the pre-doping step, the anode 18 is pulled up from the pre-doping tank 32 to be carried into the washing tank 34.

Subsequently, the anode 18 is immersed in the washing liquid 35 in the washing tank 34 for a predetermined period to be washed. Specifically, the anode 18 is carried to be passed in the washing liquid 35 over a predetermined period. At this time, the pre-doping liquid 33 remaining on the anode mixture layers 31 elutes into the washing liquid 35 to be removed. Thereafter, the anode 18 is pulled up from the washing tank 34. Through the washing step, the pre-doping liquid 33 remaining the anode 18 is removed from the anode 18 (the anode mixture layers 31).

When the anode mixture layers 31 of the anode 18 are not compressed before the pre-doping step, a compressing step therefor may be performed after the washing step.

[Secondary Battery]

A secondary battery of the present embodiment is produced (fabricated) in the same way as used for the secondary battery of the first embodiment, which is illustrated in FIG. 5.

### Third Embodiment

The present embodiment is described, referring to FIG. 10. Specifically, a description is made about a production according to the embodiment of an anode including an alkali-metal-including active material. In the embodiment, raw materials, and other structural factors/members not referred to herein are the same as in the second embodiment.

[Production of Alkali-Metal-Including Active Material]

The production of the alkali-metal-including active material has a complex-producing step, a pre-doping step, and a coat-forming step.

The complex-producing step is performed in the same way as used in the first embodiment.

In the pre-doping step, an active substance is immersed in the pre-doping liquid produced through the complex-producing step, thereby bringing the two into contact with each other to cause the two to react with each other. In this way, the active material is pre-doped with ions of the alkali metal. The pre-doping step is the same as in the second embodiment.

In the coat-forming step, the pre-doping liquid remaining on external surfaces of the active material is washed/removed, and further coats (SEI coats) are formed on the external surfaces of the active material, respectively.

In the present embodiment, a pre-doping apparatus 30 (30B) illustrated in FIG. 10 is used to perform the pre-doping step. The pre-doping apparatus 30 has a pre-doping tank 32 in which a pre-doping liquid 33 is stored; a washing tank 34 in which a coat-forming washing liquid 36 is stored for washing/removing the pre-doping liquid 33 and further forming the coats (SET coats) on the external surfaces of the active material; and others. In the embodiment, structural factors/members not referred to herein are the same as used in the pre-doping apparatus 30A of the second embodiment.

The pre-doping liquid 33 is the same as in the first and second embodiments.

The coat-forming washing liquid 36 is a solution for removing the pre-doping liquid 33 adhering onto an anode 18 and further forming a coat on any external surface of the anode active material. The coat-forming washing liquid 36 may be a solution in which a component for forming the coat is incorporated in an organic solvent of the pre-doping liquid 33. The coat-forming washing liquid 36 includes the organic solvent of the pre-doping liquid 33 to be capable of eluting out the alkali metal complex AMC of the pre-doping liquid 33. The component for forming the coat may be a conventional component (compound) usable to form an SEI coat electrochemically. The component is, for example, VC or FEC, which is to form a coat on any surface of the anode active material AM.

The anode 18 is the same as in the second embodiment.

The pre-doping apparatus 30B causes the anode 18, which is in a band form, to be carried along the longitudinal direction thereof (a direction represented by an arrow in FIG. 10). First, the pre-doping step is advanced, in which the anode 18 is immersed in the pre-doping tank 32 for a predetermined period. Specifically, the anode 18 is carried to be passed in the pre-doping liquid 33 over a predetermined period. Thereafter, the anode 18 is pulled up from the pre-doping tank 32.

Next, the anode 18 is immersed in the washing tank 34 so that the anode 18 is washed and further coats are formed on external surfaces of the anode active material. Specifically, the anode 18 is carried to be passed in the coat-forming washing liquid 36 over a predetermined period. At this time, the pre-doping liquid 33 remaining on the anode mixture layers 31 elutes into the washing liquid 35 to be removed. Simultaneously, the anode active material AM is brought into contact with the above-mentioned coat-forming component to form coats (SEI coats) on the respective external surfaces of the anode active material AM. Thereafter, the anode 18 is pulled up from the washing tank 34. By the washing, the pre-doping liquid 33 is removed from the anode, and further the coats are formed on the external surfaces of the anode active material.

[Secondary Battery]

A secondary battery of the present embodiment is produced (fabricated) in the same way as used for the secondary battery of the second embodiment.

### First Modified Embodiment of any One of Second and Third Embodiments

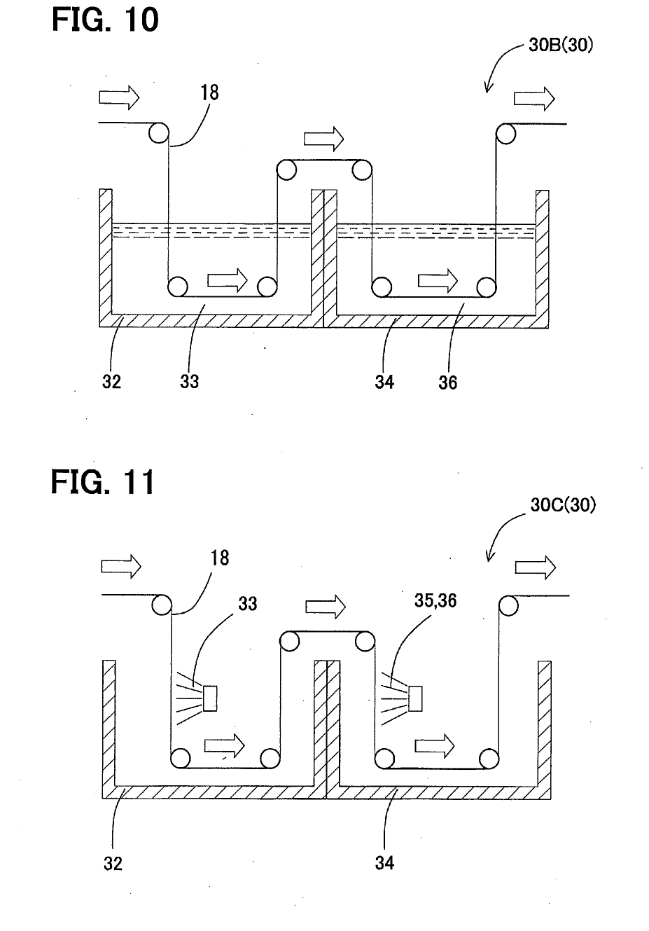

The present embodiment is identical with any one of the second and third embodiments except that the form of contact between individual liquids in a pre-doping apparatus 30 in the former embodiment is different from that in the latter embodiments. The present embodiment is described, referring to FIG. 11.

In the pre-doping apparatus 30 (30C) in the present embodiment, a pre-doping liquid 33 is blown onto an anode 18 in a pre-doping tank 32, and further a washing liquid 35 (or coat-forming washing liquid 36) is blown onto the anode 18 in a washing tank 34. By blowing the pre-doping liquid 33 onto an anode active material AM, the anode active material AM contacts a complex AMC of an alkali metal so that the two react with each other to pre-dope the anode active material AM with ions AMI of the alkali metal. Thereafter, the washing liquid 35 is blown thereonto so that the anode 18 turns into a state that the pre-doping liquid 33 does not remain on the anode 18.

### Second Modified Embodiment of any One of Second and Third Embodiments

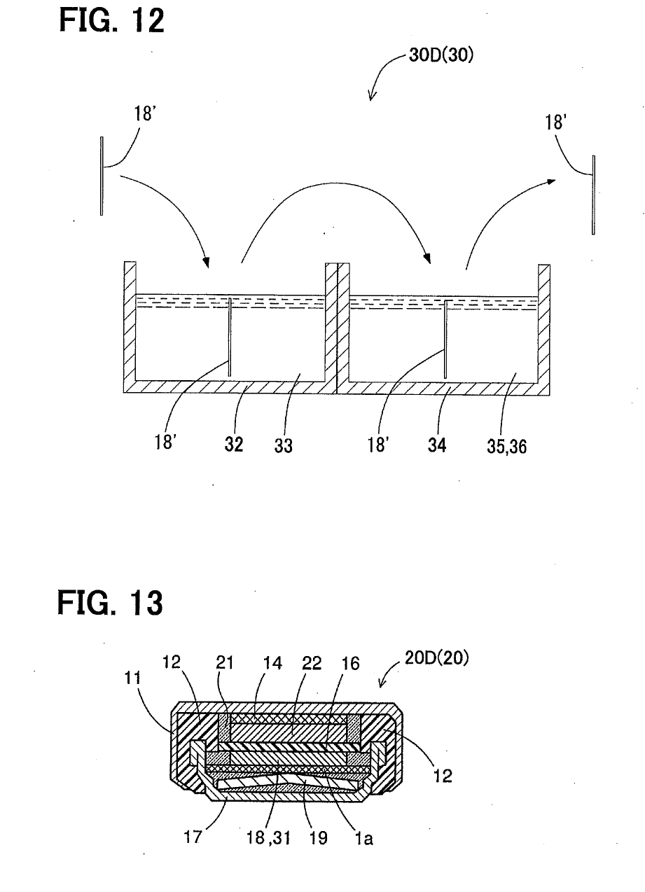

The present embodiment is identical with any one of the second and third embodiments except that the shape of an anode in the former embodiment is different from the respective anode shapes in the latter embodiments. The present embodiment is described, referring to FIG. 12.

In the present embodiment, a pre-doping apparatus 30 (30D) is used to perform pre-doping. The pre-doping apparatus 30D has a pre-doping tank 32 in which a pre-doping liquid 33 is stored; a washing tank 34 in which a washing liquid 35 (or coat-forming washing liquid 36) is stored; and others. In the embodiment, structural factors/members not referred to herein are the same as in the pre-doping apparatus 30A in the second embodiment.

An anode 18′ in the present embodiment is the same as in each of the above-mentioned embodiments except that the anode 18′ is shaped into a predetermined form (i.e., an anode shape to be used when a battery is formed, using this anode 18′; for example, a rectangular form).

The anode 18′ is immersed in the pre-doping liquid 33 in the pre-doping tank 32, and immersed in the washing liquid 35 (or coat-forming washing liquid 36) in the washing tank 34, so as to contact the liquids 33 and 35 (36) successively. In this way, a pre-doping step and a washing step are advanced.

### EXAMPLES

Working examples corresponding to the above-mentioned respective embodiments will be described with reference to Tables 1 to 3, which will be shown later. Table 1 shows data on production of alkali metal complexes; Table 2, data on production of alkali-metal-including active materials by pre-doping; and Table 3, data on performance tests of secondary batteries. The present disclosure is never limited to the working examples, and various modifications may be applied to each of the examples as far as the modified example satisfies the essential requirements. Even the modified example can produce the same advantageous effects as produced by the embodiments.

### First Example

### Production of Alkali Metal Complex

As will be specifically described below, in each of Examples A and Comparative Examples A, 2.5 g of the solvating solvent SOL shown in FIG. 1 was prepared, and 0.25 g of the ligand LIG was prepared. A metal piece of lithium was charged, as the alkali metal, into a solution of SOL+LIG to attempt the production of an alkali metal complex AMC, [ARO⁻.Li⁺.SOL]. In this way, tests for these examples were made.

### Example A1

The used solvating solvent SOL was tetrahydrofuran (THF) having a donor number of 20. The used ligand LIG was naphthalene. A coloring reaction was recognized through visual observation. As a result, it was verified that the alkali metal complex AMC was produced.

### Example A2

The used solvating solvent SOL was propylene carbonate (PC) having a donor number of 15.1. The used ligand LIG was naphthalene. A coloring reaction was recognized through visual observation. As a result, it was verified that the alkali metal complex AMC was produced.

### Example A3

The used solvating solvent SOL was ethylene carbonate (EC) having a donor number of 16.4. The used ligand LIG was naphthalene. A coloring reaction was recognized through visual observation. As a result, it was verified that the alkali metal complex AMC was produced.

### Example A4

The used solvating solvent SOL was dimethoxyethane (DME) having a donor number of 20. The used ligand LIG was naphthalene. A coloring reaction was recognized through visual observation. As a result, it was verified that the alkali metal complex AMC was produced.

### Example A5

The used solvating solvent SOL was dimethylsulfoxide (DMSO) having a donor number of 29.8. The used ligand LIG was naphthalene. A coloring reaction was recognized through visual observation. As a result, it was verified that the alkali metal complex AMC was produced.

### Example A6

The used solvating solvent SOL was tetrahydrofuran (THF) having a donor number of 20. The used ligand LIG was fluorene. A coloring reaction was recognized through visual observation. As a result, it was verified that the alkali metal complex AMC was produced.

### Example A7

The used solvating solvent SOL was tetrahydrofuran (THF) having a donor number of 20. The used ligand LIG was azulene. A coloring reaction was recognized through visual observation. As a result, it was verified that the alkali metal complex AMC was produced.

### Example A8

The used solvating solvent SOL was tetrahydrofuran (THF) having a donor number of 20. The used ligand LIG was acenaphthylene (APn). A coloring reaction was recognized through visual observation. As a result, it was verified that the alkali metal complex AMC was produced.

### Example A9

The used solvating solvent SOL was tetrahydrofuran (THF) having a donor number of 20. The used ligand LIG was biphenylene. A coloring reaction was recognized through visual observation. As a result, it was verified that the alkali metal complex AMC was produced.

### Example A10

The used solvating solvent SOL was tetrahydrofuran (THF) having a donor number of 20. The used ligand LIG was pyrene. A coloring reaction was recognized through visual observation. As a result, it was verified that the alkali metal complex AMC was produced.

### Example A11

The used solvating solvent SOL was tetrahydrofuran (THF) having a donor number of 20. The used ligand LIG was tetracene (naphthacene). A coloring reaction was recognized through visual observation. As a result, it was verified that the alkali metal complex AMC was produced.

### Example A12

The used solvating solvent SOL was tetrahydrofuran (THF) having a donor number of 20. The used ligand LIG was benzoanthracene (BAn). A coloring reaction was recognized through visual observation. As a result, it was verified that the alkali metal complex AMC was produced.

### Comparative Example A1

The used solvating solvent SOL was dioxane having a donor number of 14.8. No ligand LIG was used. No coloring reaction was recognized through visual observation. As a result, it was not verified that any alkali metal complex AMC was produced.

### Comparative Example A2

The used solvating solvent SOL was ethylene carbonate (EC) having a donor number of 16.4. No ligand LIG was used. No coloring reaction was recognized through visual observation. As a result, it was not verified that any alkali metal complex AMC was produced.

### Comparative Example A3

The used solvating solvent SOL was tetrahydrofuran (THF) having a donor number of 20. No ligand LIG was used. No coloring reaction was recognized through visual observation. As a result, it was not verified that any alkali metal complex AMC was produced.

### Comparative Example A4

The used solvating solvent SOL was dimethylsulfoxide (DMSO) having a donor number of 29.8. No ligand LIG was used. No coloring reaction was recognized through visual observation. As a result, it was not verified that any alkali metal complex AMC was produced.

The results of Examples A1 to A12 and Comparative Examples A1 to A4 are together shown in Table 1 described just below. In Table 1, some of the substances are represented by conventional English abbreviations. Naphthalene is abbreviated to “Naph” for the sake of convenience.

TABLE 1

| | | | | Alkali metal |
|---|---|---|---|---|
| | | | | complex production |
| | Solvating | Donor | | (through visual |
| | solvent | number | Ligand | observation) |
| Example A1 | THF | 20.0 | Naph | Recognized |
| Example A2 | PC | 15.1 | Naph | Recognized |
| Example A3 | EC | 16.4 | Naph | Recognized |
| Example A4 | DME | 20.0 | Naph | Recognized |
| Example A5 | DMSO | 29.8 | Naph | Recognized |
| Example A6 | THF | 20.0 | Fluorene | Recognized |
| Example A7 | THF | 20.0 | Azulene | Recognized |
| Example A8 | THF | 20.0 | APn | Recognized |
| Example A9 | THF | 20.0 | Biphenylene | Recognized |
| Example A10 | THF | 20.0 | Pyrene | Recognized |
| Example A11 | THF | 20.0 | Tetracene | Recognized |
| Example A12 | THF | 20.0 | BAn | Recognized |
| Comparative | Dioxane | 14.8 | (None) | Not recognized |
| example A1 | | | | |
| Comparative | EC | 16.4 | (None) | Not recognized |
| example A2 | | | | |
| Comparative | THF | 20.0 | (None) | Not recognized |
| example A3 | | | | |
| Comparative | DMSO | 29.8 | (None) | Not recognized |
| example A4 | | | | |

[Production of Alkali-Metal-Including Active Materials]

As will be specifically described below, in each of Examples B and Comparative Examples B, in the pre-doping apparatus 10 illustrated in FIG. 2, a metal piece of lithium was used as the alkali metal piece 15, and the active material AM was doped with ions of lithium to attempt the production of the alkali-metal-including active material AMA shown in FIG. 1. In this way, tests for these examples were made. The used anode 18 was a mixture obtained by mixing the active material, acetylene black, carboxymethylcellulose, and styrene-butadiene rubber at a ratio by mass of 90/4/3/3, and then kneading the mixed components.

### Example B1

The used pre-doping liquid 13 was the solution described in Example A1, in which the production of the alkali metal complex AMC (metal lithium complex) was verified. Specifically, the pre-doping liquid 13 was the solution including lithium ions, tetrahydrofuran (THF) and naphthalene. The used active material AM was silicon (Si). After the pre-doping liquid 13 was injected into the apparatus, it was observed through measurement that the potential and the resistance value of the anode 18 lowered. As a result, it was verified that the active material AM was pre-doped with lithium ions.

### Example B2

The used pre-doping liquid 13 was the same as in Example B1, and the used active material AM was silicon oxide (SiO). After the pre-doping liquid 13 was injected into the apparatus, it was observed through measurement that the potential and the resistance value of the anode 18 lowered. As a result, it was verified that the active material AM was pre-doped with lithium ions.

### Comparative Example B1

The used pre-doping liquid 13 was ethylene carbonate (EC), and the used active material AM was silicon (Si). After the pre-doping liquid 13 was injected into the apparatus, it was observed through measurement that the potential and the resistance value of the anode 18 did not lower. As a result, it was not verified that the active material AM was pre-doped with lithium ions.

### Comparative Example B2

The used pre-doping liquid 13 was ethylene carbonate (EC), and the used active material AM was silicon oxide (SiO). After the pre-doping liquid 13 was injected into the apparatus, it was observed through measurement that the potential and the resistance value of the anode 18 did not lower. As a result, it was not verified that the active material AM was pre-doped with lithium ions.

### Comparative Example B3

The used pre-doping liquid 13 was ethylene carbonate (EC), and the used active material AM was graphite. After the pre-doping liquid 13 was injected into the apparatus, it was observed through measurement that the potential and the resistance value of the anode 18 did not lower. As a result, it was not verified that the active material AM was pre-doped with lithium ions.

### Comparative Example B4

The used pre-doping liquid 13 was ethylene carbonate (EC) including lithium hexafluorophosphate (LiPF₆), and the used active material AM was silicon (Si). After the pre-doping liquid 13 was injected into the apparatus, it was observed through measurement that the potential and the resistance value of the anode 18 did not lower. As a result, it was not verified that the active material AM was pre-doped with lithium ions.

### Comparative Example B5

The used pre-doping liquid 13 was ethylene carbonate (EC) including lithium borofluoride (LiBF₄), and the used active material AM was silicon (Si). After the pre-doping liquid 13 was injected into the apparatus, it was observed through measurement that the potential and the resistance value of the anode 18 did not lower. As a result, it was not verified that the active material AM was pre-doped with lithium ions.

### Comparative Example B6

The used pre-doping liquid 13 was the same as in Example B1, and the used active material AM was graphite. After the pre-doping liquid 13 was injected into the apparatus, it was observed through measurement that the potential of the anode 18 lowered while the resistance thereof rose. As a result, it was verified that the active material AM was pre-doped not with lithium ions but with the alkali metal complex AMC itself (see FIG. 4).

The results of Examples B1 and B2, and Comparative Examples B1 to B6 are together shown in Table 2 described below. The same abbreviations as in Table 1 are used.

TABLE 2

| | | | | Alkali metal |
|---|---|---|---|---|
| | | | | complex production |
| | Solvating | Donor | | (through visual |
| | solvent | number | Ligand | observation) |
| Example A1 | THF | 20.0 | Naph | Recognized |
| Example A2 | PC | 15.1 | Naph | Recognized |
| Example A3 | EC | 16.4 | Naph | Recognized |
| Example A4 | DME | 20.0 | Naph | Recognized |
| Example A5 | DMSO | 29.8 | Naph | Recognized |
| Example A6 | THF | 20.0 | Fluorene | Recognized |
| Example A7 | THF | 20.0 | Azulene | Recognized |
| Example A8 | THF | 20.0 | APn | Recognized |
| Example A9 | THF | 20.0 | Biphenylene | Recognized |
| Example A10 | THF | 20.0 | Pyrene | Recognized |
| Example A11 | THF | 20.0 | Tetracene | Recognized |
| Example A12 | THF | 20.0 | BAn | Recognized |
| Comparative | Dioxane | 14.8 | (None) | Not recognized |
| example A1 | | | | |
| Comparative | EC | 16.4 | (None) | Not recognized |
| example A2 | | | | |
| Comparative | THF | 20.0 | (None) | Not recognized |
| example A3 | | | | |
| Comparative | DMSO | 29.8 | (None) | Not recognized |
| example A4 | | | | |

[Secondary Batteries]

As will be specifically described below, in each of Example C1 and Comparative Example C1, about each of the secondary batteries 20 (20A, 20B, and 20C) produced to have the respective structures illustrated in FIGS. 5 to 7, after it was verified that the active material AM was pre-doped with the alkali metal ions AMI, a performance test was made for calculating out the charge/discharge efficiency (=the discharge capacity/the charge capacity) in a first charge/discharge cycle. The material used for the cathode 22 was lithium iron phosphate (LiFeO₄). The used electrolytic solution 21 was a mixed liquid composed of 1-mol/L lithium hexafluorophosphate (LiPF₆) and a mixed solvent of ethylene carbonate (EC) and dimethyl carbonate (DMC), the ratio by mass of EC to DMC being 1/1. In the same way as used for the above-mentioned production of the alkali-metal-including active material, the used anode 18 was a mixture obtained by mixing the active material, acetylene black, carboxymethylcellulose, and styrene-butadiene rubber with each other at a ratio by mass of 90/4/3/3, and then kneading the mixed components.

### Example C1

The used anode 18 was an anode including the active material AM (silicon oxide (SiO)) pre-doped with lithium ions in Example B2. The performance test of the battery was made. As a result, the first-cycle charge/discharge efficiency was 94%.

### Comparative Example C1

The used anode 18 was an anode including the active material AM (silicon oxide (SiO)) pre-doped with none. The performance test of the battery was made. As a result, the first-cycle charge/discharge efficiency was 55%.

The results of Example C1 and Comparative Example C1 are together shown in Table 3.

TABLE 3

| | | | First-cycle |
|---|---|---|---|
| | | | charge/discharge |
| | | | efficiency |
| | | | (discharge |
| | Active | | capacity/charge |
| | material | Pre-doping | capacity) |
| Example C1 | SiO | Done | 94% |
| | | (Example B2) | |
| Comparative | SiO | Not done | 55% |
| example C1 | | | |

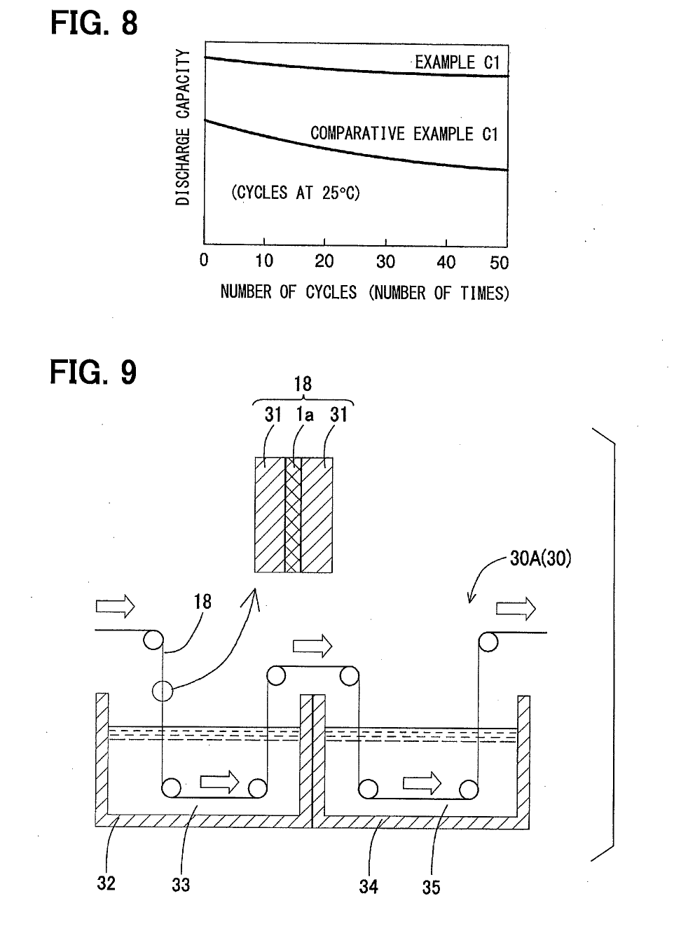

About Example C1 and Comparative Example C1, a change in the discharge capacity with an increase in the number of cycles was measured. The results are shown in FIG. 8. The discharge capacity of Example C1 was higher than that of Comparative Example C1. The discharge capacity hardly lowered in Example C1 while the discharge capacity lowered largely in Comparative Example C1. Accordingly, the secondary battery 20 can keep charge/discharge characteristics thereof over a long term.

Usually, in the first charge/discharge cycle, lithium ions in the anode 18 react with silicon oxide (SiO) of the active material AM to produce silicate (SiOₓ+Li+4e⁻→LiαSiOβ) and others. Thus, lithium atoms included in the cathode 22 are lost. Consequently, as seen in Comparative Example C1, the first-cycle charge/discharge efficiency becomes low.

However, by doping the active material AM with lithium ions, lithium atoms included in the cathode 22 are not easily lost. This would be because when silicate and others are produced in the first charge/discharge cycle, the lithium ions introduced by the pre-doping are used. As a result, the battery capacity of the secondary battery 20 increases by a quality corresponding to the lithium quantity not lost from the cathode 22.

In Examples B1 and B2, the results are shown which were each obtained by pre-doping their anode 18 with the alkali metal complex AMC (lithium metal complex). However, only the active material AM may be pre-doped. By using the active material AM the particles of which are increased by the pre-doping to produce an electrode, it is possible to restrain electrode-conduction-paths from being broken by expansion and shrinkage of the particles when the battery is charged and discharged, and also restrain other inconveniences.

The examples in which lithium (Li) was used as the alkali metal have been demonstrated, the examples being Examples A1 to A12, B1, B2 and C1.

However, any alkali metal other than lithium may be used. Examples of the metal include sodium (Na), potassium (K), rubidium (Rb), cesium (Cs), and francium (Fr). The use of sodium makes it possible to produce a sodium ion battery as the secondary battery 20. The use of potassium makes it possible to produce a potassium ion battery as the secondary battery 20. Furthermore, a multivalent ion battery can also be produced.

The pre-doping apparatus 10 in FIG. 2 used in the pre-doping step, and the secondary battery 20 in FIG. 5 were each formed in a coil-cell form. Instead of this form, the pre-doping step may be performed by using any other form to produce the alkali-metal-including active material AMA, or the secondary battery 20. Examples of the other form include a sheet form, a rectangular form, and a large-size form usable in an electric vehicle. In other words, the form may be any form that makes it possible to produce the alkali-metal-including active material AMA by pre-doping the active material AM with the alkali metal of the alkali metal complex AMC. Moreover, the secondary battery 20 may be in a form produced by use of an electrode including the pre-doped active material AM. The secondary battery 20 of the present disclosure is usable in a vehicle (the wheel number of which may be any number), a portable information terminal, a portable electronic instrument, an electric power storing device, and others.

### Second Example

In the present example, structural factors and members, and others that are not referred to were the same as in the first example.

### Example D1

### Production of Anode

In the pre-doping apparatus 30B illustrated in FIG. 10, the used pre-doping liquid 33 was the solution described in Example A1, in which the production of the alkali metal complex AMC (lithium metal complex) was verified. The used coat-forming washing liquid 36 was a mixed solution of DEC and VC.

The used anode 18 was an anode obtained by mixing the anode active material AM made of silicon, AB, CMC, and SBR at a ratio by mass of 90/4/3/3 with each other, kneading the resultant composition, painting the kneaded composition onto one of the surfaces of a band-form copper foil piece, and then drying the resultant.

The pre-doping apparatus 30B was carried along the longitudinal direction of the band-form anode 18. The anode 18 was first immersed in the pre-doping tank 32 for one hour. Thereafter, the anode 18 was carried, and immersed in the washing tank 34 for one hour.

[Secondary Battery]

About the secondary battery 20 (20D) produced to have the structure illustrated in FIG. 13, a performance test was made for gaining the first-cycle charge/discharge efficiency. The used cathode (counter electrode) was metal lithium. Its structural factors and members not referred to herein were the same as in the secondary battery 20 (20A).

As a result of the made performance test, the first-cycle charge/discharge efficiency was 96%.

### Example D2

### Production of Anode

In the pre-doping apparatus 30A illustrated in FIG. 9, the used pre-doping liquid 33 was the solution described in Example A1, in which the production of the alkali metal complex AMC (lithium metal complex) was verified. The used washing liquid 35 was DEC.

[Secondary Battery]

In the same way as in Example D1, about the secondary battery 20 (20D) produced to have the structure illustrated in FIG. 13, a performance test was made for gaining the efficiency of a first charge/discharge cycle. The used cathode (counter electrode) was metal lithium. As a result of the made performance test, the first-cycle charge/discharge efficiency was 81%.

When results of Examples D1 and D2 are compared with the results (of Comparative Example C1) in Table 3, Examples D1 and D2 were far higher in first-cycle charge/discharge efficiency than Comparative Example C1. In other words, even by immersing the anode 18 into the pre-doping liquid 32, the pre-doping can be attained so that the resultant secondary battery can exhibit the above-mentioned advantageous effects.

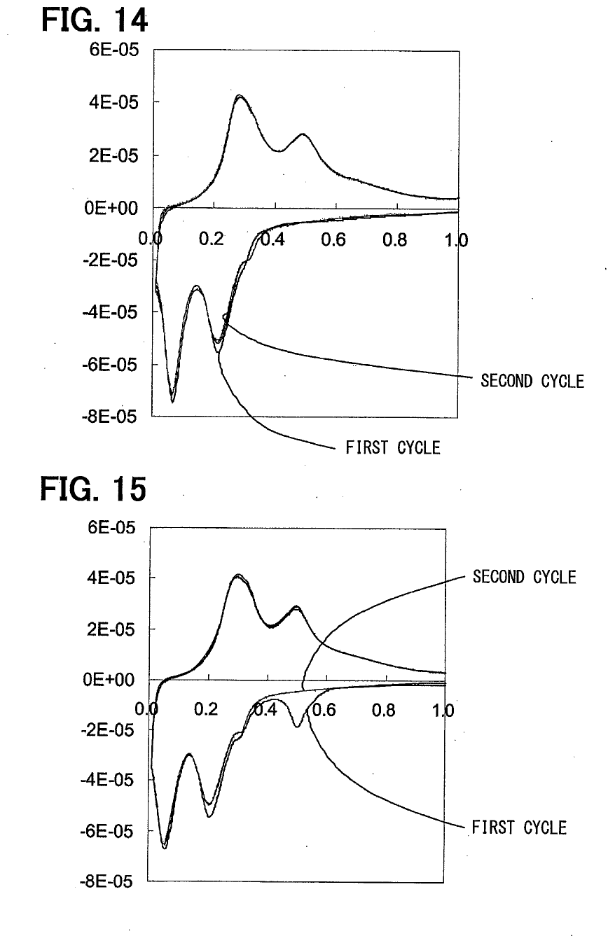

Furthermore, FIG. 14 shows the first-, and second-cycle charge/discharge characteristic of Example D1; and FIG. 15, those of Example D2.

As shown in FIG. 15, in Example D2, the first-cycle charge/discharge characteristic was lower near 0.5 V than the second-cycle characteristic. By contrast, as shown in FIG. 14, in Example D1, a difference was hardly observed between the first-, and second-cycle charge/discharge characteristics (the cycle characteristic did not lower). This matter demonstrates that when coats are formed on the external surfaces of the active material AM of the pre-doped anode 18 to fabricate a secondary battery, a fall in the cycle characteristic thereof, i.e., the battery performance thereof is restrained. The charge/discharge characteristic difference shown in FIG. 15 is generated by a matter that the components in the electrolytic solution were formed into the coats (i.e., the SEI coats) on the active material AM surfaces in the first charge/discharge cycle.

The above-mentioned embodiments and working examples can produce advantageous effects described below.

(1) A method for producing an alkali-metal-including active material AMA is invented to include: a complex-producing step of mixing an alkali metal, an organic solvent with which the alkali metal is solvated, and a ligand LIG having an electrophilic substitution reactivity with each other to produce an alkali metal complex AMC; and a pre-doping step of bringing the alkali metal complex AMC produced through the complex-producing step into contact with an active material AM to cause the two to react with each other, thereby pre-doping the active material AM with the alkali metal ions AMI. According to this method, the alkali metal is made into the complex, whereby the active material AM itself as well as the electrode can be uniformly pre-doped. The doping can easily be attained with not only lithium but also a different alkali metal difficult to handle, such as sodium or potassium. It is sufficient for this method to produce the alkali metal complex AMC to give a quantity necessary for pre-doping the active material AM; thus, an effective pre-doping with the alkali metal ions AMI can be attained so that a waste of the alkali metal can be restrained. Furthermore, the electrode can be restrained from being changed in volume to be improved in energy density.

(2) The ligand LIG may be rendered a polycyclic aromatic hydrocarbon or a polycyclic aromatic hydrocarbon group. According to this embodiment, an electrophile easily attacks its aromatic ring so that the alkali metal complex AMC is easily produced. The same advantageous effects as produced by the polycyclic aromatic hydrocarbon can be produced even by use of a compound which is not included in the category of the polycyclic aromatic hydrocarbon but has an electron (such as a π electron) that can interact with solvated Li, for example, a heterocyclic compound (which has one or more rings and may have nitrogen, oxygen, sulfur or some other element).

(3) The pre-doping step may be a step of desolvating the alkali metal complex AMC to pre-dope the active material AM with the alkali metal ions AMI.

According to this embodiment, the active material AM can be certainly pre-doped with only the alkali metal ions AMI.

(4) The donor number of the organic solvent may be 15 or more (see Table 1). This embodiment makes it easy to produce the alkali metal complex AMC.

(5) The alkali metal ions AMI may be rendered ions of lithium (see FIG. 1). This embodiment makes it easy to produce the alkali metal complex AMC including the lithium ions, so that the active material AM can be pre-doped with the lithium ions. The same advantageous effects can be produced even by ions of a different alkali metal, such as sodium or potassium.

(6) A secondary battery is configured to include an anode 18 (first electrode) including the afore-mentioned alkali-metal-including active material AMA, an electrolytic solution 21, and a cathode 22 including a material capable of occluding and releasing the alkali metal ions AMI (second electrode, which has a polarity opposite to that of the first electrode) by the intervention of an electrolytic solution 21 (see FIGS. 5 to 7). According to this configuration, the first electrode (for example, the anode 18) includes the alkali-metal-including active material AMA by the pre-doping; thus, when the battery is charged and discharged, the alkali metal is not easily lost from the second electrode (for example, the cathode 22). Accordingly, the battery capacity of the secondary battery 20 is increased by a quantity corresponding to the alkali metal quantity that has not been lost.

(7) At least the pre-doping step may be advanced after the secondary battery (20, 20B, 20C) is fabricated (see FIGS. 6 and 7). This embodiment makes it unnecessary to perform any pre-doping step (nor any complex-producing step) in advance. As a result, the secondary battery 20 (20B, 20C) is easily produced accordingly.

(8) The secondary battery (20, 20D) may be obtained through fabricating the anode (first electrode (18)) that has undergone the pre-doping step. This embodiment makes it possible to gain a secondary battery having the first electrode (for example, the anode 18) including the alkali-metal-including active material AMA through steps the number of which is small. Moreover, the anode in which the pre-doping has been completed is used to fabricate the battery; thus, the metal complex, and other compounds for the pre-doping do not remain in the secondary battery (20, 20D), so that the performance of the battery does not lower.

(9) About the anode 18 (first electrode), the active material (AM) may be immersed in a pre-doping liquid 33 (solution including the alkali metal complex AMC). This embodiment makes it possible to pre-dope the active material AM itself as well as the first electrode (for example, the anode 18) uniformly. Furthermore, the pre-doping can be continuously applied to the first electrode (for example, the anode 18) that is in a band form.

(10) The anode 18 (first electrode) may be immersed in the pre-doping liquid 33 (solution including the alkali metal complex AMC) in the state that the active material AM is arranged on an external surface of a power collector 1a. This embodiment makes it possible to pre-dope the active material AM itself as well as the first electrode (for example, the anode 18) uniformly. Furthermore, the band-form first electrode (for example, the anode 18) can be made long, and this long electrode can be continuously doped.

(11) The first electrode 18 (first electrode) may be immersed into the pre-doping liquid (solution including the alkali metal complex AMC), and subsequently washed. According to this embodiment, the pre-doping liquid comes not to remain on the first electrode (for example, the anode 18), so as not to be included in the secondary battery (20, 20D).

(12) At the same time when the anode 18 (first electrode) is washed, a coat may be formed on an external surface of the active material AM. This embodiment makes it possible to form, as this coat, a functional coat (SEI coat such as a conductive coat) on the external surface of the anode active material AM.

Furthermore, since the coat is formed at the same time of the washing, no especial step for forming the coat is required so that an excellent battery can be produced without increasing the number of producing-steps.

Additionally, after the fabrication of the secondary battery (20, 20D), no coat is formed in a first charge/discharge cycle, so that the battery is restrained from being lowered in first-cycle charge/discharge characteristic.

The above disclosure has the following aspects.

According to a first aspect of the present disclosure, a method for producing an alkali-metal-including active material by pre-doping an active material with an alkali metal ion includes: mixing the alkali metal, an organic solvent with which the alkali metal is solvated, and a ligand having an electrophilic substitution reactivity to produce an alkali metal complex; and contacting and reacting the alkali metal complex and the active material with each other to pre-dope the active material with the alkali metal ion.

According to the above method, in the complex-producing step, the alkali metal is converted into the alkali metal complex. In the pre-doping step, the active material is pre-doped with the alkali metal ions contained in the alkali metal complex. By making the alkali metal into the complex, the active material itself as well as an electrode in which the complex is used can be uniformly pre-doped with the ions. Moreover, the same can easily be pre-doped with not only lithium but also a different alkali metal difficult to handle, such as sodium or potassium. Furthermore, it is sufficient for the present disclosure that the alkali metal complex is produced by a quantity necessary for being blended with the active material. Thus, the same can be efficiently pre-doped with the alkali metal ions to restrain a waste of the alkali metal.

According to a second aspect of the present disclosure, a secondary battery includes: a first electrode including the alkali-metal-including active material produced by the producing method according to the first aspect; an electrolytic solution; and a second electrode that has a polarity opposite to the first electrode, and includes a material for absorbing and releasing the alkali metal ion with the electrolytic solution.

According to the above battery, the first electrode (for example, the anode) contains the alkali-metal-containing active material by the pre-doping. Thus, when the present battery is electrically charged or discharged, the alkali metal is not easily lost from the second electrode (for example, the cathode). Accordingly, the battery capacity of the secondary battery is increased by a quantity corresponding to the alkali metal quantity that has not been lost.

Alternatively, at least a pre-doping step may be advanced after the secondary battery is fabricated. In this case, after the provisional secondary battery is fabricated (that is, when the battery is in the state of not being electrically charged), at least the pre-doping step is advanced so that the active material contained in the first electrode can be pre-doped with the alkali metal ions. Only the pre-doping step may be advanced, or the complex-producing step and the pre-doping step may be advanced. After the active material is pre-doped with the alkali metal ions, the alkali metal is not easily lost from the second electrode (for example, the cathode) at the time of the electric charge or the discharge. Accordingly, the battery capacity of the secondary battery is increased by a quantity corresponding to the alkali metal quantity that has not been lost.

Alternatively, the secondary battery may be obtained through fabricating the first electrode after performing a pre-doping step. In this case, it is unnecessary to cause the inside of the secondary battery to have a structure for the pre-doping. Thus, the secondary battery does not include, therein, any complex or the like for the pre-doping. As a result, the secondary battery does not include, therein, any substance that does not contribute to charge and discharge, so that the energy density of the secondary battery is restrained from being lowered while the effect of the pre-doping is exhibited. Furthermore, without fabricating any provisional secondary battery, a secondary battery having a pre-doped first electrode can be obtained. In the first electrode (18) subjected to the pre-doping step, a coat is preferably formed on an external surface of the active material after the pre-doping step.

Some terms are defined as follows: The term “alkali metal” is any element belonging to Group I of the periodic table, and is lithium, sodium, potassium, rubidium, cesium, or francium. The alkali metal may be a simple substance, or may be, in a broad sense, an alloy containing any alkali metal. The term “alkali-metal-containing active material” is an active material containing ions of an alkali metal.

The term “ligand” is a material having electrophilic substitution reactivity, which is a property of being attacked by an electrophile. The ligand is, for example, an aromatic compound. The aromatic compound is desirably a polycyclic aromatic hydrocarbon or a polycyclic aromatic hydrocarbon group. Examples of a coordinating group of the ligand include sulfonic, hydroxyl, amino, phosphino, carboxyl, and thiol groups.

The term “polycyclic aromatic hydrocarbon” is an aromatic compound having two or more rings, and is composed of carbon and hydrogen atoms. The term “polycyclic aromatic hydrocarbon group” is a mixture of two or more polycyclic aromatic hydrocarbons.

The “organic solvent” may be any organic solvent, or any mixed solvent in which two or more organic solvents are mixed with each other. In order to produce an alkali metal complex with a higher certainty, the donor number of the solvent is preferably 15 or more, the number being to be detailed below. Desired examples thereof include cyclic carbonates, cyclic esters, linear esters, cyclic ethers, linear ethers, and nitriles.

The “donor number” is also called Gutmann donor number. Using a matter that antimony pentachloride is a strong Lewis acid in which the atom of Sb receives an electron pair from a Lewis base to come to have a hexa-coordinate structure, the term “donor number” of an organic solvent is defined as follows: as a reference base, 1,2-dichloroethane is selected, and therein a measurement is made about the reaction heat (AH) of a reaction between antimony pentachloride and the organic solvent, which is a target to be measured (and acts as an electron donor); the reaction is an endothermic reaction, and the measured value of ΔH is represented in the unit of kcal/mol; and then a value obtained by changing the sign of the represented value is defined as the donor number.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A method for producing an alkali-metal-including active material by pre-doping an active material with an alkali metal ion comprising:
mixing the alkali metal, an organic solvent with which the alkali metal is solvated, and a ligand having an electrophilic substitution reactivity to produce an alkali metal complex; and
contacting and reacting the alkali metal complex and the active material with each other to pre-dope the active material with the alkali metal ion.

2. The method for producing the alkali-metal-including active material according to claim 1,
wherein the ligand includes at least one of a polycyclic aromatic hydrocarbon and a polycyclic aromatic hydrocarbon group.

3. The method for producing the alkali-metal-including active material according to claim 1,
wherein the contacting and reacting includes: desolvating the alkali metal complex to pre-dope the active material with the alkali metal ion.

4. The method for producing the alkali-metal-including active material according to claim 1,
wherein the donor number of the organic solvent is equal to or larger than fifteen.

5. The method for producing the alkali-metal-including active material according to claim 1,
wherein the alkali metal ion is at least one of a lithium ion, a sodium ion and a potassium ion.

6. A secondary battery comprising:
a first electrode including the alkali-metal-including active material produced by the producing method according to claim 1,
an electrolytic solution; and
a second electrode that has a polarity opposite to the first electrode, and includes a material for absorbing and releasing the alkali metal ion with the electrolytic solution.

7. The secondary battery according to claim 6,
wherein at least a pre-doping step is advanced after the secondary battery is fabricated.

8. The secondary battery according to claim 6, which is obtained through fabricating the first electrode after performing a pre-doping step.

9. The secondary battery according to claim 8,
wherein in the first electrode, the active material is immersed in a solution including the alkali metal complex.

10. The secondary battery according to claim 9,
wherein the first electrode is immersed in the solution including the alkali metal complex under a condition that the active material is arranged on an external surface of a power collector.

11. The secondary battery according to claim 8,
wherein the first electrode is washed after contacting the first electrode and the solution including the alkali metal complex.

12. The secondary battery according to claim 11,
wherein a coat is formed on an external surface of the active material simultaneously with a washing step of the first electrode.
